(19) United States
(12) Patent Application Publication
(10) Pub. No.: US 2010/0192301 A1
(43) Pub. Date: Aug. 5, 2010

(54) Extremity support apparatus for an emergency cot

(76) Inventor: Michael C. Di Lauro, Carlsbad, CA (US)

Correspondence Address: G. L. LOOMIS & ASSOCIATES, INC., 990 HIGHLAND DRIVE, SUITE 212Q, SOLANA BEACH, CA, 92075, US

(21) Appl. No.: 12/366,610

(22) Filed: Feb. 5, 2009

(51) Int. Cl. A47C 7/54; A61G 1/04

(52) U.S. Cl. 5/621; 297/411.23

(57) ABSTRACT

The invention provides an adjustable apparatus, which is removedly attachable to a medical emergency cot, gurney, wheeled stretcher or the like, and that functions to support and immobilize of an extremity of a human body, i.e. limb, during patient transport. The apparatus consists of a cot attachment member to which is attached a movable linkage, an extension pole assembly and an extremity support member and wherein certain combinations of relative movements of the movable linkage, the extension pole assembly and the extremity support member allow the apparatus to be disposed and secured in positions that support an extremity of a patient lying on the emergency cot and wherein other combinations of relative movements allow the apparatus to be disposed and secured in a storage position beneath the surface of the cot.

### FIELD OF THE INVENTION

The present invention relates generally to extremity supporting devices for use in combination with the patient transporters currently used in hospitals and ambulances, and specifically to an adjustable support device for maintaining an extremity of a patient in a supported position during transport.

### BACKGROUND OF THE INVENTION

Various types of ambulatory and medical emergency cots, gurneys, wheeled stretchers and the like are utilized in patient transport and it is frequently necessary to administer medication or other fluids intravenously during transport by introducing a conduit into a body extremity of the patient. Most commonly the body extremity is an arm. In order to avoid injury and ensure proper administration, it is important that the patient's body extremity remain relatively immobile and straightened during the procedure. This is particularly important when the patient is transported in a moving vehicle, wherein the close quarters and abrupt movements can combine to produce a potentially hazardous environment. Additionally embodiments of the present invention can be used in combination with blood drawing stations such as phlebotomy chairs.

U.S. Pat. No. 3,528,413 to Aydt describes a splint for an injured arm that attaches to the rail of a bed or a field stretcher wherein the arm splint is attached to the rail via a c-clamp and provides only limited adjustability. Also, since the described arm splint encases the extremity, it does not permit transcutaneous access to the blood vessels of the extremity and therefore precludes procedures such as intravenous therapy.

U.S. Pat. No. 5,443,233 to Kabanek discloses an arm board for a gurney comprising a stiff flat board that not attached to the gurney, but that is rather slipped into crevice below the mattress and thus is held in place by the weight of the patient. Such an arm board configuration is limited in that it fails to provide any adjustability and requires that the arm of the patient be maintained in the same plane as the body.

U.S. Pat. No. 5,839,136 to Vance et al. describes an emergency cot mounted arm board that includes a cot frame attaching member, an arm board, and a pivot assembly coupling the attaching member and the arm board. However the arm board of this invention has limited adjustability since it is attached to the backrest and necessarily remains parallel to the horizontal plane of the cot. Furthermore, with such a configuration the arm board position changes if the position of the backrest is changed during transport of the patient.

U.S. Pat. No. 6,701,554 to Heimbrock discloses a transportable stretcher used in medical imaging with a pivotally coupled armboard. Since this stretcher is designed specifically for imaging procedures utilizing a C-arm apparatus, the pivotally coupled arm board provides only limited adjustability.

It is therefore an object of the present invention to provide a device, attachable to a medical emergency cot, gurney or wheeled stretcher, to stabilize a body extremity during transport of a patient wherein the device can be easily positioned.

It is another object of the present invention to provide a device, attachable to a medical emergency cot, gurney or wheeled stretcher, to stabilized a body extremity during transport of a patient wherein the device can be positioned to avoid unwanted pressure or tension on a limb.

It is another object of the present invention to provide a device, attachable to a medical emergency cot, gurney or wheeled stretcher, to stabilize a body extremity during transport of a patient wherein the device is rigid in design to minimize vibration during patient transport.

It is another object of the present invention to provide a device, attachable to a medical emergency cot, gurney or wheeled stretcher, to support a body extremity during transport of a patient in a manner that permits transcutaneous access to the blood vessels of the extremity and therefore allows performance of procedures such as intravenous therapy.

It is another object of the present invention to provide a device, attachable to a medical emergency cot, gurney or wheeled stretcher, to stabilized a body extremity during transport of a patient wherein the device can be conveniently adjusted to fit the full range patient sizes.

It is another object of the present invention to provide a device, attachable to a medical emergency cot, gurney or wheeled stretcher, to stabilize a body extremity during transport of a patient that provides for convenient and effective immobilization of a patient's extremity if the position of the backrest is changed during transport.

It is another object of the present invention to provide a device, attachable to a medical emergency cot, gurney or wheeled stretcher, to stabilized a body extremity during transport of a patient wherein the device can be positioned to not exceed the boundary planes defined by the emergency cot when not in use.

It is another object of the present invention to provide a device, attachable to a medical emergency cot, gurney or wheeled stretcher that can be used in combination with to a phlebotomy chair so that the present invention stabilizes and holds the extremity in the extended position to safely and effectively draw blood.

It is another object of the present invention to provide an adjustable apparatus that is attachable to an arm of a chair for use in phlebotomy procedures.

These and other objects of the present invention will be apparent from a review of the following specification and accompanying drawings.

### BRIEF DESCRIPTION OF THE DRAWINGS

FIG. 1 is a partially exploded isometric view of an extremity support apparatus disposed in an extended position attached to a medical cot.

FIG. 2 is an assembled isometric view of the extremity support apparatus of FIG. 1 disposed in an extended position attached to a medical cot.

FIG. 3 is an isometric view of the extremity support apparatus of FIG. 2. disposed in a storage position attached to a medical cot.

FIG. 4 is an orthogonal side view of a medical cot with an extremity support apparatus disposed in an extended position.

FIG. 5 is a detailed view of the extremity support apparatus of FIG. 4.

FIG. 6 is an orthogonal end view of a medical cot with an extremity support apparatus disposed in an extended position.

FIG. 7 is an orthogonal rear view of an extension assembly and an extremity support member of a support apparatus in an extended position.

FIG. 8 is an orthogonal side view of an extension assembly and an extremity support member of a support apparatus in an extended position.

FIG. 9 is a front orthogonal rear view of an extension assembly and an extremity support member of a support apparatus in an extended position.

FIG. 10 is an isometric frontal view of an extremity support apparatus in a partially extended position depicting a rod/perforated plate locking mechanism.

FIG. 10A is an isometric rear view of an extremity support apparatus in a partially extended position depicting a rod/perforated plate locking mechanism.

FIG. 11 is an isometric frontal view of an extremity support apparatus in a storage position depicting a rod and rod/perforated plate locking mechanism.

FIG. 11A is an isometric rear view of an extremity support apparatus in a storage position depicting a rod and rod/perforated plate locking mechanism.

FIG. 12 is an isometric view of an embodiment of a four-bar linkage of an extremity support apparatus disposed in a partially extended position while attached to a rail of a medical cot.

FIG. 13 is an isometric view of an embodiment of a four-bar linkage of an extremity support apparatus disposed in a partially extended position while attached to a rail of a medical cot.

FIG. 14 is an isometric view of an embodiment of a moveable linkage, in the form of a hinged coupling, of an extremity support apparatus disposed in a partially extended position while attached to a rail of a medical cot.

FIG. 15 is an isometric view of an embodiment of a moveable linkage, in the form of a hinged coupling, of an extremity support apparatus disposed in a partially extended position while attached to a rail of a medical cot.

FIG. 16 is an isometric view of an embodiment of an extremity apparatus attached to an arm of a chair for use in phlebotomy procedures.

### SUMMARY OF THE INVENTION

The present invention provides an adjustable device, which is removedly attachable to a medical emergency cot, gurney, wheeled stretcher or the like, that functions to support and immobilize an extremity of a human body, i.e. limb, during transport. The device is of simple construction and yet rigid and easily adjustable in five modes from three or four quickly accessible adjustment points. The apparatus can support the limb in a stationary position and can be tilted from two horizontal pivot points and rotated around a vertical axis. A preferred configuration comprises a main support section or member comprising two ends, wherein the first end is pivotally mounted to a clamp which is fastened to the rail of a medical emergency bed or cot; an end-support means pivotally mounted on the main member at the second end; and an adjustable limb retaining means rotatably mounted on the end-support. Such an apparatus is of simple construction and yet permits a high degree of adjustability.

A typical embodiment of such an apparatus attachable to an emergency cot has a cot attachment member to which is attached a movable linkage; rotatably coupled to the movable linkage is an extension pole assembly comprising an outer tube and an inner tube telescopically coupled within the outer tube to which an extremity support member is rotatably coupled; wherein certain combinations of relative movements of the movable linkage, the extension pole assembly and the extremity support member allow the apparatus to be disposed and secured in positions that support an extremity of a patient lying on the emergency cot and wherein other combinations of relative movements of the movable linkage, the extension pole assembly and the extremity support member allow the apparatus to be disposed and secured in a storage position beneath the surface of the cot. Certain embodiments of apparatuses of the present invention are particularly suitable for use in combination with to a phlebotomy chair so that the present invention stabilizes and holds the extremity in the extended position to safely and effectively draw blood.

In certain embodiments the moveable linkage is a four-bar linkage, a three-bar linkage, a hinged coupling or a ball-joint linkage. In certain preferred embodiments of the extremity support apparatus, a rail of the cot to which the apparatus is attached defines one bar of the four-bar linkage. In certain embodiments the four bar linkage further comprises a locking mechanism comprising a rod and perforated flat plate mechanism.

In certain embodiments of the extremity support apparatus of the present invention at the extension pole assembly and/or the support member is provided with a locking means including but not limited to a friction clamp having a lead screw, a quick release clamp having a non-circular cam and a friction collar.

In certain preferred embodiments the apparatus has a diagonal brace member with a body having a proximal end, a distal end and a slot extending through the body along its longitudinal axis from a point near the distal end and extending to a point at least past the center point of the longitudinal axis, wherein the proximal end of the diagonal brace is pivotally attached to the movable linkage and wherein the extension pole assembly comprises a pin slidably coupled through the slot of the diagonal support such that the diagonal brace member functions to impart rigidity and strength the apparatus as the extension pole assembly is pivotally rotated relative to the movable linkage.

In certain other preferred embodiments the cot attachment member comprises one or more C-clamps. In certain other preferred embodiments the extremity support member is contoured to conform to the shape of a patient's extremity and in yet other embodiments the extremity support member further comprises a replaceable pad.

In certain other embodiments of the apparatus of the present invention the cot attachment member is fixedly attachable to a frame component of a cot by a means such as welding to afford a unitary construction.

The present invention also provides a method of affording extremity support for a patient being transported in an emergency cot comprising the steps of: i. providing an extremity support apparatus of the present invention; ii. attaching the apparatus to an emergency cot; iii. adjusting and securing the apparatus in a position appropriate for supporting a patient's extremity; and iii. disposing the patient's extremity within the support member.

Other embodiments of the present invention provide an adjustable apparatus that is attachable to an arm of a chair for use in phlebotomy procedures. In such embodiments the apparatus is attachable to an arm of a suitable chair and certain combinations of relative movements of the movable linkage, the extension pole assembly and the extremity support member allow the apparatus to be disposed and secured in positions that support an arm of a patient sitting in the chair for a phlebotomy procedure. A method of affording arm support for a patient seated in a chair for a phlebotomy procedure comprises the steps of: i. providing a suitable arm support apparatus of the present invention; ii. attaching the apparatus to the arm of the a suitable chair; iii. adjusting and securing the apparatus in a position appropriate for supporting a patient's arm; and iii. disposing the patient's extremity within the support member.

### DETAILED DESCRIPTION OF THE INVENTION

For purposes of the present invention the terms medical emergency cot, gurney, transport stretcher, ambulance stretcher, wheeled stretcher and patient transfer stretcher are synonymous.

For purposes of the present invention a four-bar linkage also referred to as a 4-bar or four-bar is the well known movable linkage consisting of four rigid bodies, often called bars or links, each attached to two others by single joint or pivots to form a closed loop.

For purposes of the present invention a three-bar linkage also referred to as a 3-bar or three-bar is a well-known movable linkage consisting of three rigid bodies, a three-bar linkage is often employed in place of a conventional four-bar linkage

Embodiments of the present invention provide an adjustable apparatus, which is attachable to a medical emergency cot, gurney, wheeled stretcher or the like to support and immobilize an extremity of a human body, i.e. limb, during transport of a patient. In general such an apparatus has a cot attachment member attachable to a cot; a movable linkage fixedly attached to the cot attachment member; an extension pole assembly comprising an outer tube with a proximal end and a distal end, wherein the outer tube proximal end is pivotably attached to the movable linkage, and an inner tube with a proximal end and a distal end wherein the inner tube proximal end is telescopically coupled within the outer tube; and an extremity support member rotatably coupled to the distal end of the inner tube of the extension pole assembly, wherein certain combinations of relative movements of the movable linkage, the extension pole assembly and the extremity support member allow the apparatus to be disposed and secured in positions that support an extremity of a patient lying on the emergency cot and wherein other combinations of relative movements of the movable linkage, the extension pole assembly and the extremity support member allow the apparatus to be disposed and secured in a storage position beneath the surface of the cot.

Suitable cot attachment members can be in the form of one or more of a variety of C-clamps; G-clamps; band clamps, such as T-bolt band clamps or worm gear band clamps; straps or the like.

The moveable linkage can be a three-bar linkage, a four-bar linkage, a slidable linkage, a hinged coupling, a ball-joint linkage or any similar coupling that permits the overall positioning of the apparatus in a function extremity support position as well as a storage position.

In certain embodiments the cot attachment member is fixedly attachable to the cot and in certain other embodiments the cot attachment member is removedly attachable to the cot. In certain preferred embodiments the cot attachment member is attachable to a side rail of the cot.

In certain preferred embodiments the moveable linkage is a four-bar linkage is attached to the cot attachment member such that movements of the four-bar linkage are in the plane of the cot surface. The telescopic coupling of the outer tube and an inner tube of the extension pole assembly which renders these tubes slidably and rotatably movable with respect to one another, while the extremity support member is rotatably coupled to the distal end of the inner tube of the extension assembly. Such a configuration of components permits a combination of movements or adjustments of the components to deploy and secure the apparatus in the optimum position to function as an effective support for an extremity of a patient, while other combinations of movements or adjustments permits the apparatus to be secured in a protected storage position beneath the surface of the cot.

In certain embodiments the extremity support member has a brace that is contoured to conform to the shape of the patients extremity to be supported.

In certain preferred embodiments the apparatus is further provided with a slotted diagonal brace member one end of which is pivotally attached to an edge of the four-bar linkage by means of a pin or other suitable coupling means and the extension assembly has a pin that extends through the slot in the brace member thereby slidably coupling the diagonal brace to the extension assembly such that the diagonal brace member functions to impart and maintain rigidity and strength to the apparatus as the extension assembly in all extremity support positions of the extension assembly.

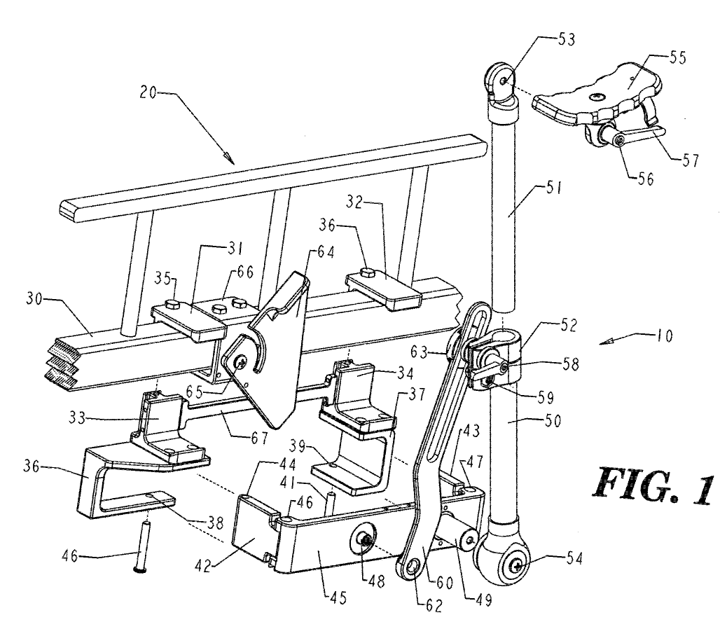

In FIG. 1 is illustrated a partially exploded isometric view of a typical embodiment of an extremity support apparatus 10 of that clearly shows the relationship of the individual components. Two cot attachment members each in the form of a C-clamp consist of upper C-clamp elements 31 and 32 slidably coupled to lower C-clamp elements 33 and 34 respectively wherein each cot attachment member is provided with a screw 35 and 36 that couples with a hole in the lower C-clamp elements and functions as a locking means to secure the cot attachment members to frame rail 30 of hospital cot side rail 20. Such an arrangement permits facile attachment or removal of the extremity support apparatus to or from the cot. Also in the embodiment illustrated in FIG. 1 an optional spacer bar 67 is coupled to lower C-clamp elements 33 and 34 and functions to hold the position of elements 33 and 34 such that the rotation of side elements 42 and 43 remains parallel. Such an optional spacer functions as an aid to the attachment of the two cot attachment members to a cot and further functions to add rigidity to the apparatus. Attached to lower C-clamp elements 33 and 34 respectively are four-bar linkage rear elements 36 and 37, which in turn are hingedly attached to four-bar linkage side elements 42 and 43 while a four-bar linkage front element 45 is hingedly attached to four-bar linkage side elements 42 and 43. In some embodiments of the four-bar linkage as depicted in FIG. 1, which do not employ the optional spacer bar 67, it is the frame rail 30 that in essence functions as a one bar of the four-bar linkage.

Further depicted in FIG. 1 is an extension assembly with an inner tube 51 telescopically and rotatably coupled within an outer tube 50 and an extremity support member 55 rotatably coupled to the extension assembly by means of a pin or rod 56 that passes through a hole 53 in the distal end of the inner tube 51. In this depicted embodiment the extremity support member 55 has a top surface that is contoured to conform to the shape of a patients' extremity and has an extremity support component locking means 57 in the form of a lever actuated friction clutch mechanism or a compressive force exerted by a lead screw. Also, in the embodiment depicted in FIG. 1 the apparatus 10 is further provided with a slotted diagonal brace member 60 having a diagonal brace attachment element 62 at the proximal end that is pivotably attached to a mating attachment element 48 on the front plate 45 of the four-bar linkage and wherein the extension assembly outer tube 50 is slidably coupled to the diagonal brace member 60 via a pin 58 extending through a collar 52 around the extension assembly outer tube 50 and through the slot in the slotted diagonal brace member 60. The diagonal brace member 60 functions to impart and maintain overall rigidity and strength to the extremity support apparatus when the apparatus 10 is disposed in an extended functional position. A diagonal brace member locking means in the form of a lever actuated friction clutch mechanism 58 is used to maintain the diagonal brace member 60 in a desired position as well as to secure the collar 52 to the outer tube 50. Also depicted as an optional component is a retaining plate 64, which is pivotably attached to a retaining plate C-clamp 66 by means of a bolt 65.

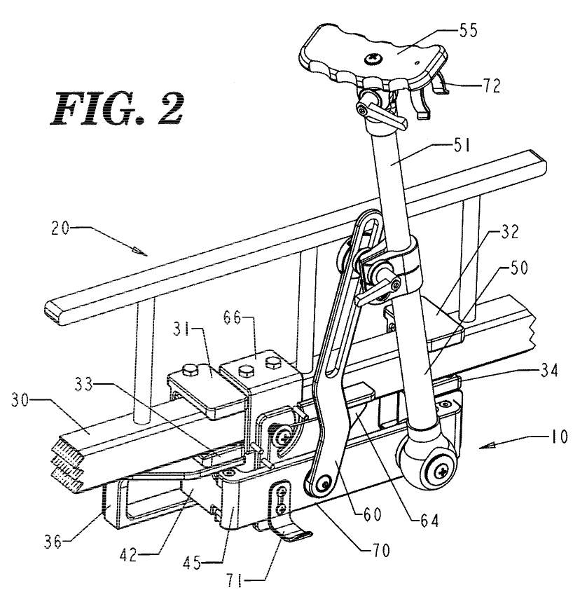

In FIG. 2 is presented an isometric view of the extremity support apparatus 10 depicted FIG. 1 wherein the components are fully assembled and is disposed in an extended functional position. In FIG. 2 to the four-bar linkage front element 45 further comprises a cradle in the form of a hook 71 which functions to accommodate and aid in securing the extension assembly when the apparatus is in the storage position.

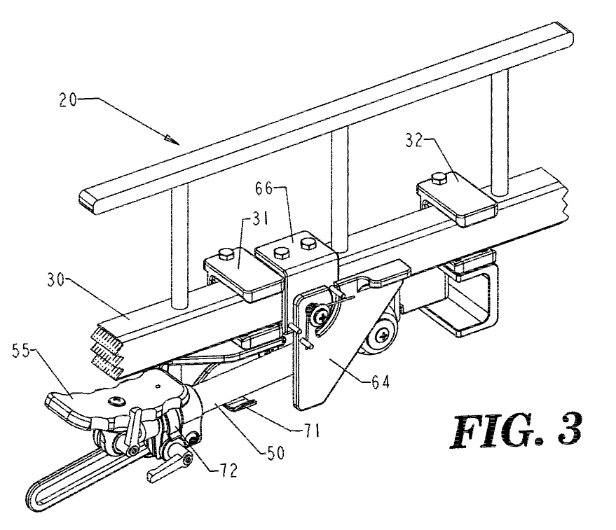

In FIG. 3 is presented an isometric view of the extremity support apparatus 10 wherein the components are fully assembled and wherein the apparatus 10 is disposed in a storage position under the frame rail 30 of hospital cot side rail 20. Also as illustrated in FIG. 3 the retaining plate 64 is rotated into a position wherein the top edge is parallel to the frame rail 30 wherein the retaining plate 64 functions to aid in the retention of apparatus 10 is in the storage position.

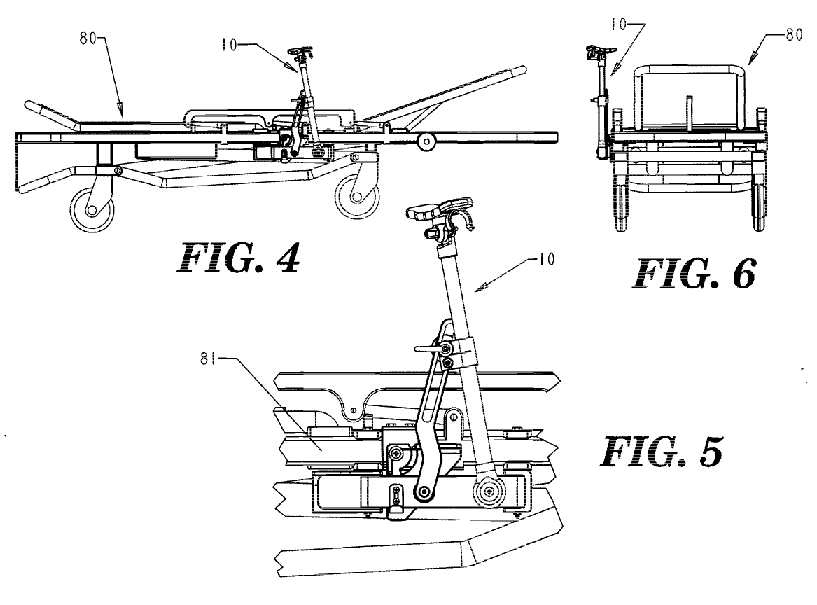

Depicted in FIG. 4 is an orthogonal side view of a medical cot 80 to which is affixed an extremity support apparatus 10, wherein the apparatus 10 is disposed in an extended functional position. FIG. 5 is a detailed view of the extremity support apparatus 10 of FIG. 4 showing the attachments to a frame rail 81. Depicted in FIG. 6 is an orthogonal end view of medical cot 80 with extremity support apparatus 10 disposed in an extended functional position.

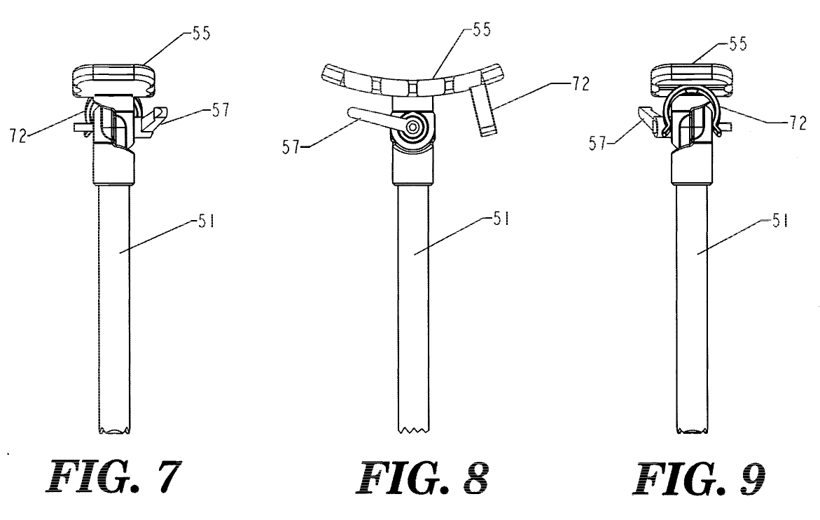

Illustrated in FIG. 7 is an orthogonal rear view of an extension assembly inner tube 51 rotatably coupled to extremity support member 55 disposed in a functional position. FIG. 8 presents an orthogonal side view of the extension assembly inner tube 51 rotatably coupled to extremity support member 55 disposed in a functional position and FIG. 9 presents a frontal orthogonal rear view of the extension assembly inner tube 51 rotatably coupled to extremity support member 55 disposed in a functional position. The locking mechanism 57 depicted in FIGS. 7, 8 and 9 allows for retention in a desired position of the extremity support member 55 relative to extension assembly inner tube 51. Also depicted is an open spring clamp 72 sized to accommodate and retain the extension assembly inner tube 51 when the apparatus is in a storage position.

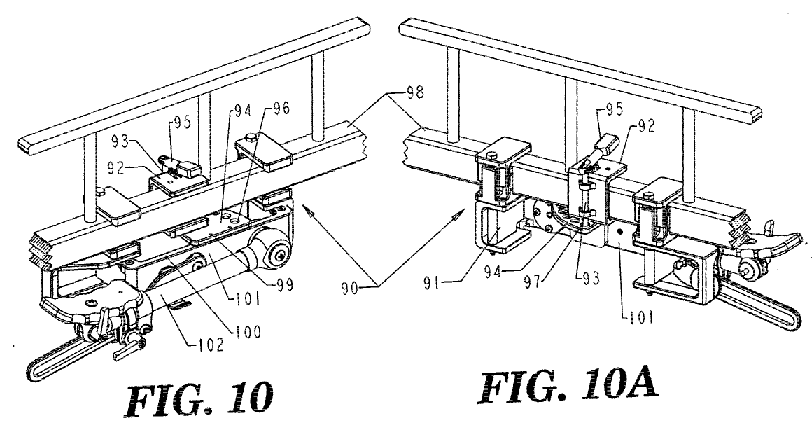

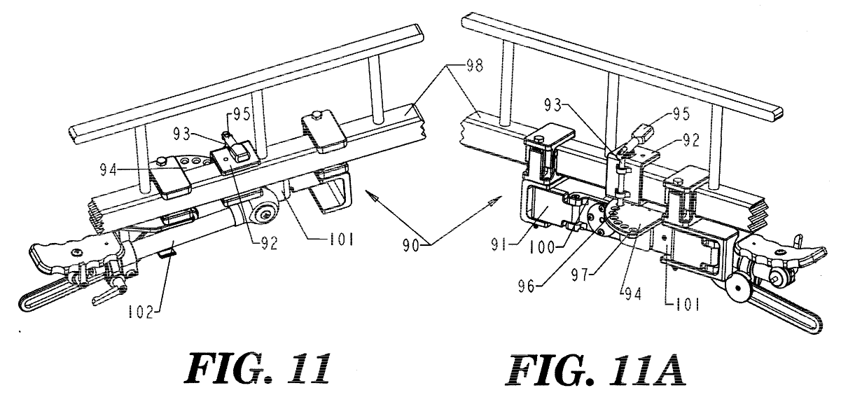

Illustrated in FIGS. 10, 10A, 11 and 11A is an embodiment of an extremity support apparatus of the present invention that includes a locking mechanism incorporating a locking rod 93 and perforated flat plate 94 to retain a four-bar linkage 90 and the extension assembly 102 attached thereto in either an extended position or a storage position. In FIG. 10 is depicted is an isometric frontal view of an apparatus attached to a cot frame rail 98 wherein the four-bar linkage 90 is in an extended position, while in FIG. 10A is depicted is an isometric rear view of an apparatus attached to a cot frame rail 98 wherein the four-bar linkage 90 is in an extended position. In FIG. 11 is depicted is an isometric frontal view of an apparatus attached to a cot frame rail 98 wherein the four-bar linkage 90 is in a storage position, while in FIG. 11A is depicted is an isometric rear view of an apparatus attached to a cot frame rail 98 wherein the four-bar linkage 90 is in a storage position. The perforated flat plate 94 has a front edge 99 fixedly attached to a top edge 100 of the frontal four-bar linkage element 101. In such a configuration the perforated flat plate 94 to is perpendicular to the frontal four-bar linkage element 101 and moves under the cot frame rail 98 as the four-bar linkage 90 is extended and retracted. A locking rod 93 is slidably attached to a rod retaining C-clamp 92 such that the locking rod 93 is always perpendicular to the plane of the perforated flat plate 94 and wherein the locking rod 93 is dimensioned to fit through the perforations in the perforated flat plate 94 that extend around the perimeter from the frontal perforation 96 to the rear perforation 97 (see FIG. 10A). To engage the desired perforation the locking rod 93 is raised and lowered as necessary by the action of the locking rod lever 95, which is hingedly attached to the topmost extremity of the locking rod 93. In FIGS. 10 and 10A the locking rod 93 is engaged in the rear perforation 97 thereby locking and retaining the four-bar linkage 90 in an extended position. In FIGS. 11 and 11A the locking rod 93 is engaged in the frontal perforation 96 thereby locking and retaining the four-bar linkage 90 in a storage position beneath the cot frame rail 98. In certain embodiments the locking rod lever 95 is provided with a spring mechanism that holds the locking rod 93 in a lowered position, such that it can engage and extend through a perforation in the perforated flat plate 94 and wherein depressing the locking rod lever 95 raises the locking rod 93 to disengage it from a perforation and allows the perforated flat plate 94 to move when the four-bar linkage 90 is extended.

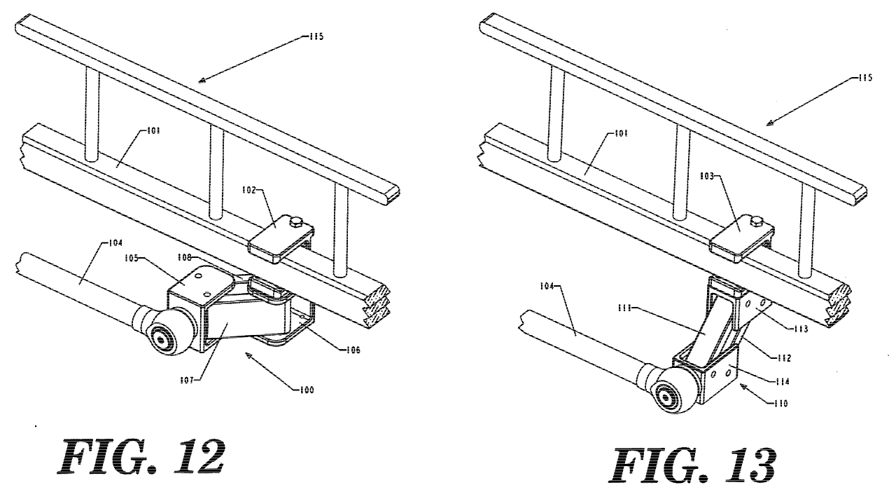

In FIG. 12 is illustrated an isometric view of an embodiment of a four-bar linkage of an extremity support apparatus of the present invention. The four-bar linkage 100 is attached to a medical cot frame rail 101 by a C-clamp 102 and is disposed in a partially extended position. The four-bar linkage 100 comprises: a first four-bar linkage end component 105 rotatably attached to extension assembly 104; a second four-bar linkage end component 106 fixedly attached to the C-clamp 102; a first four-bar linkage plate 107 having a first end disposed within and hingedly attached to the first four-bar linkage end component 105 and a second end disposed within and hingedly attached to the second four-bar linkage end component 106; and a second four-bar linkage plate 108 having a first end disposed within and hingedly attached to the first four-bar linkage end component 105 and a second end disposed within and hingedly attached to the second four-bar linkage end component 106. Such a configuration permits movement the extremity support apparatus of which four-bar linkage 100 is a component to move freely in a plane parallel to the plane of the medical cot side rail 115.

In FIG. 13 is illustrated an isometric view of another embodiment of a four-bar linkage of an extremity support apparatus of the present invention. The four-bar linkage 110 is attached to a medical cot frame rail 101 by a C-clamp 103 and is disposed in a partially extended position. The four-bar linkage 110 comprises: a first four-bar linkage end component 114 rotatably attached to extension assembly 104; a second four-bar linkage end component 113 fixedly attached to the C-clamp 103; a first four-bar linkage plate 111 having a first end disposed within and hingedly attached to the first four-bar linkage end component 114 and a second end disposed within and hingedly attached to the second four-bar linkage end component 113; and a second four-bar linkage plate 112 having a first end disposed within and hingedly attached to the first four-bar linkage end component 114 and a second end disposed within and hingedly attached to the second four-bar linkage end component 113. Such a configuration permits movement the extremity support apparatus of which four-bar linkage 110 is a component to move freely in a plane perpendicular to the plane of the medical cot side rail 115.

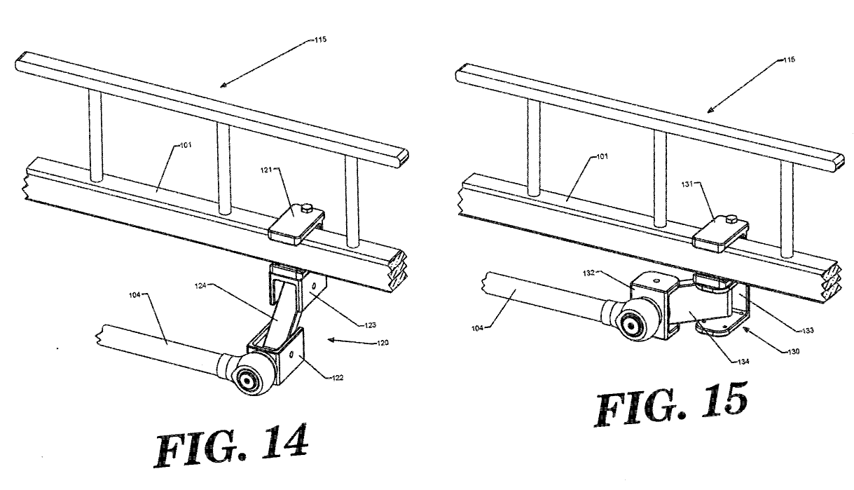

In FIG. 14 is illustrated an isometric view of an embodiment of a moveable linkage, in the form of a hinged coupling 120 of an extremity support apparatus of the present invention. The hinged coupling 120 is attached to a medical cot frame rail 101 by a C-clamp 121 and is disposed in a partially extended position. The hinged coupling 120 comprises: a first hinged coupling end component 122 rotatably attached to extension assembly 104; a second hinged coupling end component 123 fixedly attached to the C-clamp 121; and a hinged coupling plate 124 having a first end disposed within and hingedly attached to the first hinged coupling end component 122 and a second end disposed within and hingedly attached to second hinged coupling end component 123. Such a configuration permits movement the extremity support apparatus of which the hinged coupling 120 is a component to move freely in a plane perpendicular to the plane of the medical cot side rail 115.

In FIG. 15 is illustrated an isometric view of an embodiment of a moveable linkage, in the form of a hinged coupling 130 of an extremity support apparatus of the present invention. The hinged coupling 130 is attached to a medical cot frame rail 101 by a C-clamp 131 and is disposed in a partially extended position. The hinged coupling 130 comprises: a first hinged coupling end component 132 rotatably attached to extension assembly 104; a second hinged coupling end component 133 fixedly attached to the C-clamp 131; and a hinged coupling plate 134 having a first end disposed within and hingedly attached to the first hinged coupling end component 132 and a second end disposed within and hingedly attached to second hinged coupling end component 133. Such a configuration permits movement the extremity support apparatus of which the hinged coupling 130 is a component to move freely in a plane parallel to the plane of the medical cot side rail 115.

Certain embodiments of the present invention provide an adjustable apparatus, which is attachable to an arm of a chair useful in phlebotomy procedures. Such embodiments comprise: a chair attachment member attachable to an arm of the chair; a movable linkage attached to the chair attachment member; an extension pole assembly comprising an outer tube with a proximal end and a distal end, wherein the outer tube proximal end is pivotably attached to the movable linkage, and an inner tube with a proximal end and a distal end wherein the inner tube is telescopically coupled within the outer tube; and an extremity support member rotatably coupled to the distal end of the inner tube of the extension pole assembly; wherein certain combinations of relative movements of the movable linkage, the extension pole assembly and the extremity support member allow the apparatus to be disposed and secured in positions that support an arm of a patient sitting in the chair for a phlebotomy procedure. The moveable linkages, attachment members, extension pole assemblies and extremity support members herein described for the cot-attachable embodiments are also suitable for the chair-attachable embodiments.

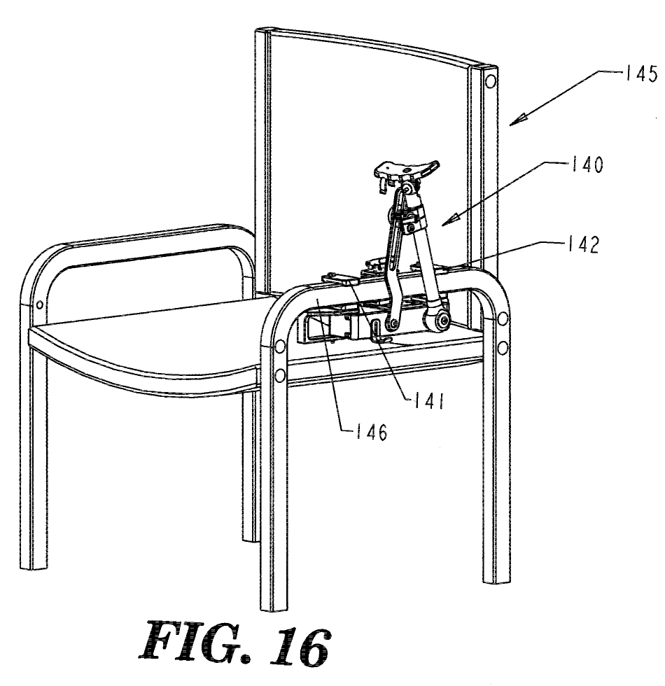

Depicted in FIG. 16 is an isometric view of an extremity support apparatus 140 affixed to a chair arm 146 of chair 145, wherein the apparatus 140 is suitably disposed in an extended functional position to accept the forearm of a patient seated in chair 145 for a phlebotomy procedure. In this embodiment, illustrated as extremity support apparatus 140, the chair attachment member comprises C-clamps 141 and 142, which are attached to chair arm 146.

Preferred construction materials for components of embodiments extremity support apparatuses of the present invention include, but are not limited to, metal such as aluminum or stainless steel, and most preferably stainless steel. Use of such metals decreases the likelihood of rusting and/or pitting of components and increases the ease of cleaning. Also use of such materials imparts a substantial durability and sturdiness to the apparatus.

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

We claim:

1. An apparatus attachable to an emergency cot comprising:
a cot attachment member;
a movable linkage attached to the cot attachment member;
an extension pole assembly comprising an outer tube with a proximal end and a distal end, wherein the outer tube proximal end is pivotably attached to the movable linkage, and an inner tube with a proximal end and a distal end wherein the inner tube is telescopically coupled within the outer tube; and
an extremity support member rotatably coupled to the distal end of the inner tube of the extension pole assembly;
wherein certain combinations of relative movements of the movable linkage, the extension pole assembly and the extremity support member allow the apparatus to be disposed and secured in positions that support an extremity of a patient lying on the emergency cot and wherein other combinations of relative movements of the movable linkage, the extension pole assembly and the extremity support member allow the apparatus to be disposed and secured in a storage position beneath the surface of the cot.

2. The apparatus of claim 1 wherein the movable linkage is a four-bar linkage, a three-bar linkage, a hinged coupling or a ball-joint linkage.

3. The apparatus of claim 2 wherein the movable linkage is a four-bar linkage.

4. The apparatus of claim 2 wherein a rail of the cot to which the apparatus is attached defines one bar of the four-bar linkage.

5. The apparatus of claim 3 further comprising a locking mechanism comprising a rod and perforated flat plate mechanism.

6. The extremity support apparatus of claim 1 wherein at least one of the extension pole assembly and the support member is provided with a locking means.

7. The apparatus of claim 2 wherein the locking means is selected from the group consisting of a friction clamp having a lead screw, a quick release clamp having a non-circular cam and a friction collar.

8. The apparatus of claim 7 wherein the locking means is a friction collar.

9. The apparatus of claim 1 further comprising a diagonal brace member with a body having a proximal end, a distal end and a slot extending through the body along its longitudinal axis from a point near the distal end and extending to a point at least past the center point of the longitudinal axis, wherein the proximal end of the diagonal brace is pivotally attached to the movable linkage and wherein the extension pole assembly comprises a pin slidably coupled through the slot of the diagonal support such that the diagonal brace member functions to impart rigidity and strength the apparatus as the extension pole assembly is pivotally rotated relative to the movable linkage.

10. The apparatus of claim 1 wherein the cot attachment member comprises one or more C-clamps.

11. The apparatus of claim 1 wherein the extremity support member is contoured to conform to the shape of a patient's extremity.

12. The apparatus of claim 1 wherein the extremity support member further comprises a replaceable pad.

13. The apparatus of claim 1 wherein the cot attachment member is fixedly attachable to a frame component of a cot.

14. An apparatus attachable to a phlebotomy chair comprising:
a chair attachment member attachable to an arm of the chair;
a movable linkage attached to the chair attachment member;
an extension pole assembly comprising an outer tube with a proximal end and a distal end, wherein the outer tube proximal end is pivotably attached to the movable linkage, and an inner tube with a proximal end and a distal end wherein the inner tube is telescopically coupled within the outer tube; and
an extremity support member rotatably coupled to the distal end of the inner tube of the extension pole assembly; wherein
certain combinations of relative movements of the movable linkage, the extension pole assembly and the extremity support member allow the apparatus to be disposed and secured in positions that support an arm of a patient sitting in the chair for a phlebotomy procedure.

15. The apparatus of claim 14 wherein the movable linkage is a four-bar linkage, a three-bar linkage, a hinged coupling or a ball-joint linkage.

16. The extremity support apparatus of claim 14 wherein at least one of the extension pole assembly and the support member is provided with a locking means.

17. The apparatus of claim 16 wherein the locking means is selected from the group consisting of a friction clamp having a lead screw, a quick release clamp having a non-circular cam and a friction collar.

18. The apparatus of claim 14 further comprising a diagonal brace member with a body having a proximal end, a distal end and a slot extending through the body along its longitudinal axis from a point near the distal end and extending to a point at least past the center point of the longitudinal axis, wherein the proximal end of the diagonal brace is pivotally attached to the movable linkage and wherein the extension pole assembly comprises a pin slidably coupled through the slot of the diagonal support such that the diagonal brace member functions to impart rigidity and strength the apparatus as the extension pole assembly is pivotally rotated relative to the movable linkage.

19. The apparatus of claim 14 wherein the chair attachment member comprises one or more C-clamps.

20. A method of affording extremity support for a patient being transported in an emergency cot comprising the steps of:
i. providing the apparatus of claim 1;
ii. attaching the apparatus to an emergency cot;
iii. adjusting and securing the apparatus in a position appropriate for supporting a patient's extremity; and
iii. disposing the patient's extremity within the support member.
